(19) United States
(12) Patent Application Publication
(10) Pub. No.: US 2015/0029164 A1
(43) Pub. Date: Jan. 29, 2015

(54) ATTACHABLE ACCESSORY AND METHOD FOR COMPUTER RECORDING OF WRITING

(71) Applicant: HON HAI PRECISION INDUSTRY CO., LTD., New Taipei (TW)

(72) Inventor: PO-CHUN LIU, New Taipei (TW)

(21) Appl. No.: 14/340,742

(22) Filed: Jul. 25, 2014

(30) Foreign Application Priority Data
Jul. 26, 2013 (TW) 102127006

(51) Int. Cl. G06F 3/0354; B43K 29/08

(52) U.S. Cl. CPC G06F 3/03545; B43K 29/08; G06F 3/04883
USPC 345/179

(57) ABSTRACT

An accessory for digitally recording writing on a surface includes an accessory body, a sensing panel, a gyroscope, an accelerating sensor, and a processor. The accessory body is fastened to a pen. The sensing panel is located on the accessory body to sense being held in a hand. The gyroscope can determine an inclination angle shift of the body relative to a predefined writing plane. The accelerating sensor can detect an offset of the body within the predefined writing plane. The processor can simulate the writing according to the inclination angle shift and the offset and record and display the writing.

### CROSS-REFERENCE TO RELATED APPLICATIONS

This application claims priority to Taiwanese Patent Application No. 102127006 filed on Jul. 26, 2013 in the Taiwan Intellectual Property Office, the contents of which are incorporated by reference herein.

### FIELD

The subject matter herein generally relates to an attachable accessory and a method for computer recording of a writing.

### BACKGROUND

Handwriting on a surface can used to record information. To record the handwriting to a computer, the handwriting has to be scanned through a scanner.

### BRIEF DESCRIPTION OF THE DRAWINGS

Implementations of the present technology will be described, by way of example only, with reference to the attached figures.

FIG. 1 is an isometric view of a pen and an accessory according to one embodiment.

FIG. 2 is a block diagram of the electronic elements of the accessory of FIG. 1.

FIG. 3 is a diagrammatic view of the pen with the accessory in a held state.

FIG. 4 is a diagrammatic view of the pen with the accessory in a recording state.

FIG. 5 is a method for digitally recording a writing according to one embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to mean essentially conforming to the particular dimension, shape, or other feature that the term modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The present disclosure describes a attachable accessory attached to pen or other writing tool to digitally record a writing on a surface.

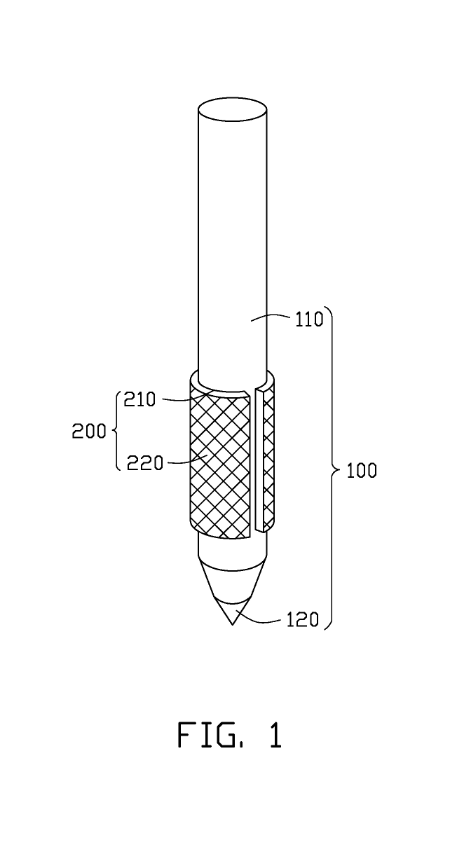

FIG. 1 illustrates an example embodiment of a pen 100 and a accessory 200. The pen 100 includes a pen holder 110 and a pen point 120. The accessory 200 can be attached to the holder 110. The accessory 200 includes a body 210 and a sensing panel 220 located on the body 210. A cross section of the body 210 can be circular or substantially C-shaped. The body 210 can be deformable to facilitate fastening to the pen holder 110. The sensing panel 220 can be covered on the body 210.

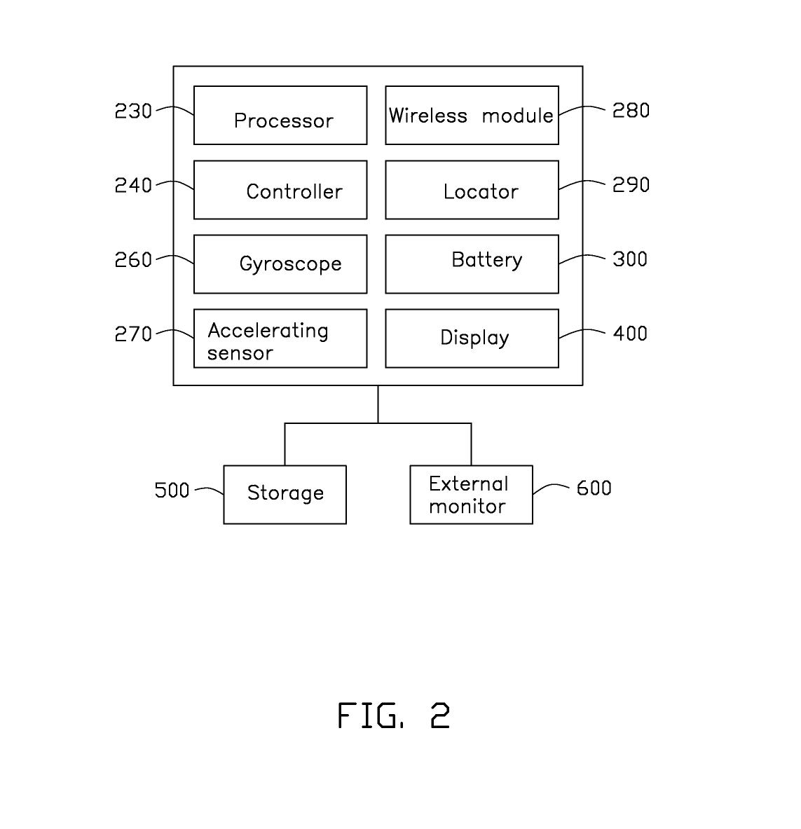

FIG. 2 illustrates an example embodiment of a block view of components of the accessory 200. The accessory 200 further includes a processor 230, a controller 240, a gyroscope 260, an accelerating sensor 270, a wireless module 280, a locator 290, a battery 300, and a display 400. The sensing panel 220, the controller 240, the gyroscope 260, the accelerating sensor 270, the wireless module 280, the locator 290, the battery 300, and the display 400 are coupled to the processor 230. The controller 240, the gyroscope 260, the accelerating sensor 270, the wireless module 280, the locator 290, and the battery 300 can be located in the body 210.

The controller 240 can define a predefined writing plane. The predefined writing plane can be horizontal, vertical, or other angled plane. The controller 240 can control a working state of the sensing panel 220, the gyroscope 260, the wireless module 280, and the battery 300.

The locator 290 can detect a distance between the gyroscope 260 and the surface along the central axis of the pen 100.

The wireless module 280 can be a near field communication (NFC) module, a WIFI module, or a BLUETOOTH® module. The processor 230 can send data through the wireless module 280 to a storage 500 or to an external monitor 600.

The battery 300 can supply power to other components, and can be a chargeable battery.

The display 400 can display a power state of the battery 300 and record information such as time and wireless activity. The display 400 can be a touch sensitive screen.

The gyroscope 260 can determine an inclination angle and changes in the inclination angle of the body 210 relative to the predefined writing plane.

The accelerating sensor 270 can detect an offset of the body within the predefined writing plane.

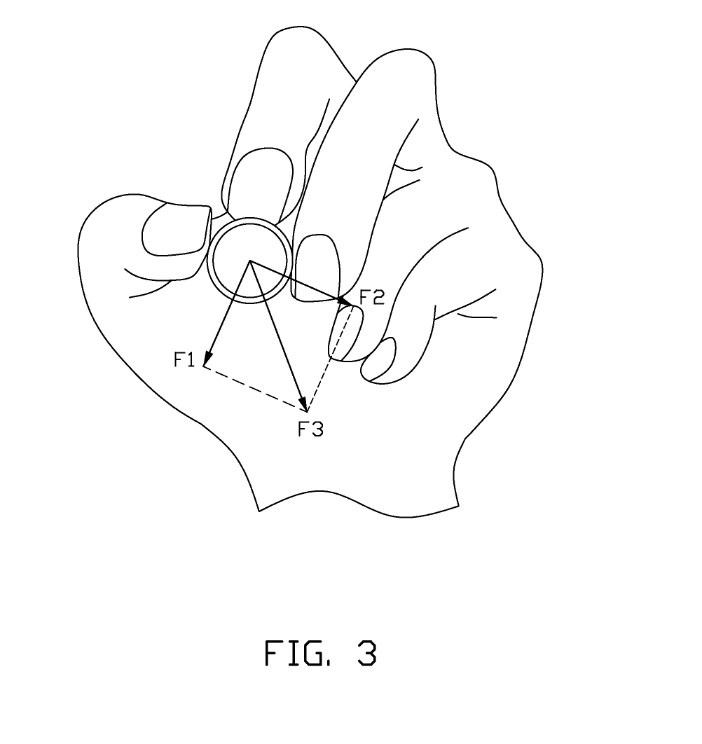

FIG. 3 illustrates a diagrammatic view of the accessory being held in the hand.

The processor can detect if the accessory is held in the hand. For example, the sensing panel can receive a pressure force F1 and a pressure force F2 caused by pressure of fingers at right angle to central axis of pen. The processor can calculate a resulting force F3 and determine if the resulting force F3 is greater than a predefined force to determine if the pen pool is being held in the hand.

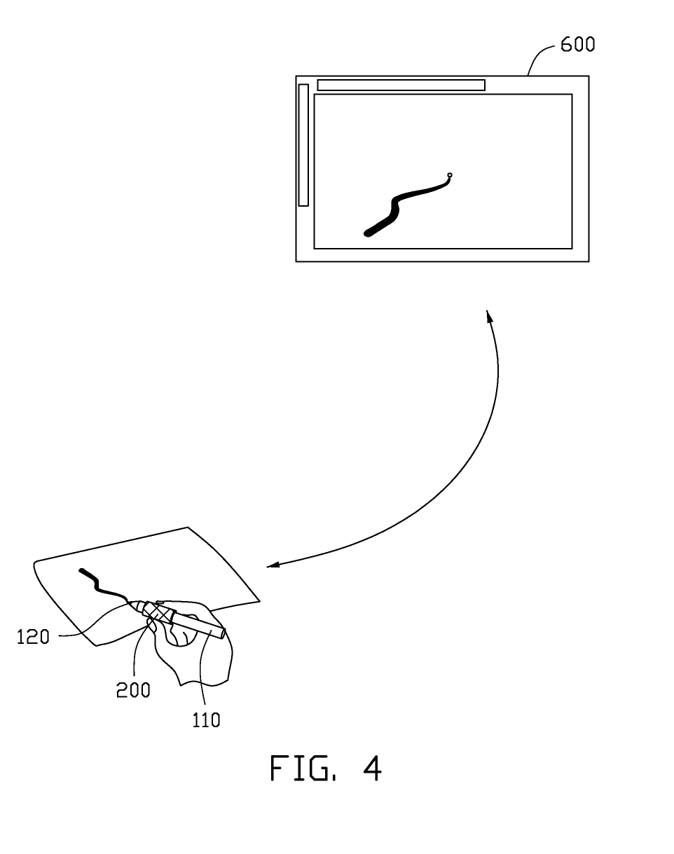

FIG. 4 illustrates a diagrammatic view of the pen with the accessory in a recording state. The processor can simulate writing done by the pen point 120 according to the inclination angle shift and the offset, and output the simulated writing to the external display 600. The simulated writing can have different scales. The processor can also calculate a practical writing in same scale on the surface according to the lifting distance and the simulated writing.

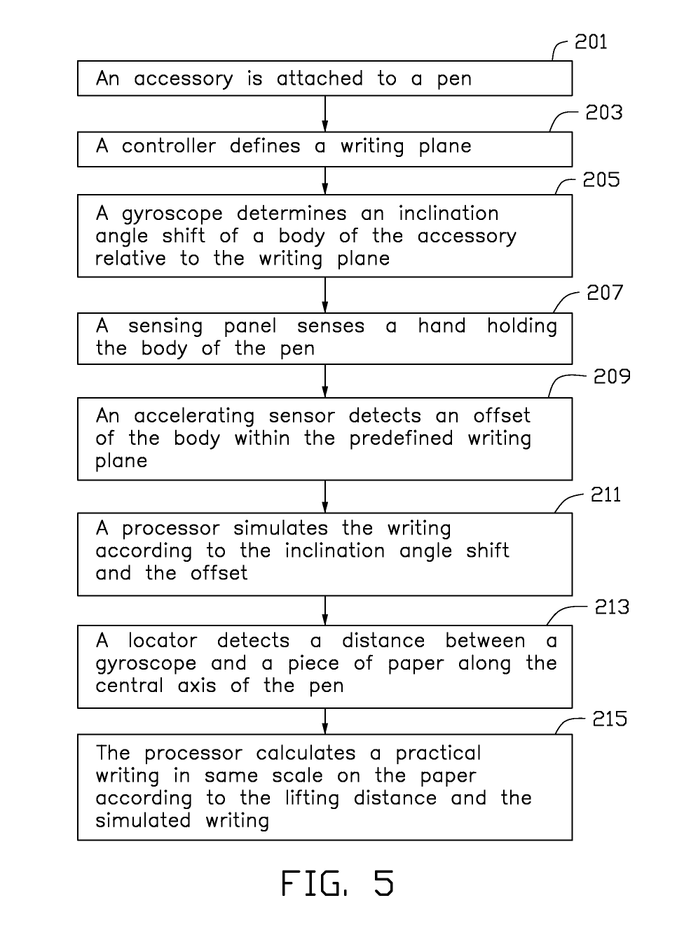

FIG. 5 illustrates a method for computer recording of writing digitally. The method includes the following blocks.

At block 201, an accessory is attached to a pen.

At block 203, a controller defines a writing plane.

At block 205, a gyroscope determines an inclination angle shift of a body of the accessory relative to the writing plane.

At block 207, a sensing panel senses a hand holding the body of the pen.

At block 209, an accelerating sensor detects an offset of the body within the predefined writing plane.

At block 211, a processor simulates the writing according to the inclination angle shift and the offset.

At block 213, a locator detects a distance between a gyroscope and a piece of paper along the central axis of the pen.

At block 215, the processor calculates a practical writing in same scale on the paper according to the lifting distance and the simulated writing.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including the details of shape, size, and arrangement of the parts within the principles of the present disclosure, up to and including the full extent established by the broad general meaning of the terms used in the claims.

What is claimed is:

1. A attachable accessory for recording a writing digitally comprising:
a body fastened to a pen;
a sensing panel located on the body to sense a hand holding;
a gyroscope configured to determine an inclination angle shift of the body relative to a predefined writing plane;
an accelerating sensor configured to detect an offset of the body within the predefined writing plane; and
a processor being configured to simulate the writing according to the inclination angle shift and the offset.

2. The attachable accessory of claim 1, further comprising a battery located on the body.

3. The attachable accessory of claim 1, wherein the body is deformably fastened to the pen.

4. The attachable accessory of claim 1, wherein the sensing panel is covered on the body.

5. The attachable accessory of claim 1, wherein a cross section of the body is substantially C-shaped.

6. The attachable accessory of claim 1, further comprising a locator, wherein the locator is configured to detect a lifting distance between the gyroscope and the surface along the pen.

7. The attachable accessory of claim 6, wherein the processor is configured to calculate a practical writing on the surface according to the lifting distance and the simulated writing.

8. The attachable accessory of claim 1, further comprising a wireless module, wherein the processor is further configured to send the simulated writing through the wireless module.

9. The attachable accessory of claim 1, further a controller, wherein the controller is configured to set the predefined plane, and control the sensing panel and the gyroscope.

10. A method for computer recording of writing digitally comprising:
attaching a attachable accessory on a pen;
defining a writing plane of the pen;
determining an inclination angle shift of a body of the attachable accessory relative to the writing plane through a gyroscope;
sensing a hand holding through a sensing panel on the body;
detecting an offset of the body within the predefined writing plane through an accelerating sensor; and
simulating the writing according to the inclination angle shift and the offset through a processor.

11. The method of claim 10, further comprising detecting a lifting distance between the gyroscope and the surface along the pen.

12. The method of claim 11, further comprising calculating a practical writing on a surface according to the lifting distance and the simulated writing.

13. The method of claim 10, further comprising sending the simulated writing through a wireless module.

14. The method of claim 10, wherein the body is deformably fastened to the pen.

15. The method of claim 10, wherein the sensing panel is covered on the body.

16. The method of claim 10, wherein a cross section of the body is substantially C-shaped.

17. A manual writing accessory for recording manual writing on a predetermined writing plane, comprising:
an attachable body, attachable to a manual writing implement;
a sensing panel attached to the attachable body;
a gyroscope to determine a position of a tip of the manual writing implement relative to the predetermined writing plane;
an accelerating sensor for sensing movement of the tip relative to the predetermined writing plane; and
a processor;
wherein, the sensor determines when the manual writing implement is held by a user and activates the gyroscope, accelerating sensor and processor;
wherein, processor receives position data from the gyroscope and movement data from the accelerating sensor and calculates data determining contact of the writing implement tip with the predetermined plane; and
wherein, tip contact data is used to simulate the manual writing of the manual implement user.
